(19) United States
(12) Patent Application Publication
(10) Pub. No.: US 2004/0059062 A1
(43) Pub. Date: Mar. 25, 2004

(54) Golf balls, golf ball compositions, and methods of manufacture

(76) Inventor: Hyun Jin Kim, Carlsbad, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 10/251,315

(22) Filed: Sep. 20, 2002

(51) Int. Cl. C08L 33/04

(52) U.S. Cl. 525/222

(57) ABSTRACT

Golf balls incorporate compositions incorporating ethylene vinyl acetate polymer or ethylene vinyl acetate/acid terpolymer, having specified physical properties, and crosslinking agent, co-crosslinking agent, crosslinking accelerator, or mixtures of these. An additional blend polymer also may be incorporated into the compositions. The golf balls provide flexibility in golf ball design to improve ball performance, such as hit feel and spin rate, without adversely affecting shear-cut resistance of the ball. Also, methods for making golf balls include preparing a composition comprising ethylene vinyl acetate polymer, ethylene vinyl acetate/acid terpolymer, or mixtures of these, along with crosslinking agent, co-crosslinking agent, crosslinking accelerator, or mixtures of these, and then incorporating the composition into a golf ball. The methods can include injection molding only, or injection and compression molding. Preferred methods include inducing partial or total crosslinking of the composition at preferred steps of making the golf balls.

### BACKGROUND OF THE INVENTION

This invention relates generally to golf balls and golf ball compositions and, more particularly, to golf balls and golf ball compositions designed to optimize ball performance. This invention also relates to methods of manufacture of such golf balls and golf ball compositions.

Golf balls generally include a core and at least one layer surrounding the core. Balls can be classified as two-piece, wound, or multilayer balls. Two-piece balls include a spherical inner core and an outer cover layer. Wound balls include a core, a rubber thread wound under tension around the core to a desired diameter, and a cover layer. Cover layers for wound ball generally are made of trans-polyisoprene or thermoset polyurethane. Multilayer balls include a core, a cover layer, and one or more intermediate layers.

Generally, two-piece balls have good durability and distance when hit, but poor “feel”—the overall sensation transmitted to the golfer while hitting the ball—and low spin rate, which results in poor ball control. Wound balls having balata covers generally have high spin rate, leading to good control, and they also have good feel, but they have poor durability and short distance in comparison to two-piece balls. Multi-layer balls generally have performance characteristics between those of two-piece and wound balls; that is, multi-layer balls exhibit durability and distance inferior to two-piece balls but superior to wound balata balls, and they exhibit feel and spin rate inferior to wound balata balls but superior to two-piece balls.

Material characteristics of the compositions used in the core, cover, and any intermediate layers of golf balls are among the important factors that determine the performance of the balls. In particular, the composition of the cover layer is important in determining the ball's durability, shear-cut resistance, speed, spin rate, hitting sound (the sound made by a golf club head when it hits the ball), and feel. The composition of an intermediate layer is important in determining the ball's spin rate and speed. Various materials having different physical properties are used to make cover and intermediate layers to create a ball having the most desirable performance possible. In particular, cover layers of many commercially available balls are made using soft or hard ionomeric resins, elastomeric resins, or blends of these.

Ionomeric resins used generally are ionomeric copolymers of an olefin and a metal salt of a unsaturated carboxylic acid, or ionomeric terpolymers having a co-monomer within its structure. These resins vary in resiliency, flexural modulus, and hardness, based on differing acid content, degree of neutralization, and metal cation used for neutralization. Examples of these resins include those marketed under the trademark SURLYN manufactured by E. I. DuPont de Nemours & Company of Wilmington, Del., and IOTEK manufactured by Exxon Mobil Corporation of Irving, Tex. Ionomeric copolymers have been particularly favored for use in golf ball covers because they produce ball covers having excellent durability and high resilience. Ionomeric terpolymers are used to produce covers having improved spin and feel, though at the cost of ball speed and durability. Elastomeric resins used in golf ball covers include a variety of thermoplastic or thermoset elastomers available, such as polyurethane, polyetherester elastomer, and polyamide elastomer.

Each of the materials discussed above has particular characteristics that can lead to good golf ball properties when used in a golf ball composition, either for making a ball cover or intermediate layer. However, one material generally cannot optimize all of the important properties of a golf ball layer. Properties such as feel, speed, spin rate, resilience, and durability all are important, but improvement of one of these properties by use of a particular material often can lead to worsening of another. For example, ideally, a golf ball cover should have good feel and controllability, without sacrificing ball speed, distance, or durability. Despite the broad use of copolymeric ionomers in golf balls, their use alone in, for example, a ball cover can be unsatisfactory. A cover providing good durability, controllability, and feel would be difficult to make using only a copolymeric ionomer resin having a high flexural modulus, because the resulting cover, while having good distance and durability, also will have poor feel and low spin rate, leading to reduced controllability of the ball. Also, use of particular elastomeric resins alone can lead to compositions having unsatisfactory properties, such as poor durability and low ball speed.

Therefore, to improve golf ball properties, the materials discussed above can be blended to produce improved ball layers. Prior compositions for golf balls have involved blending high-modulus copolymeric ionomer with, for example, lower-modulus copolymeric ionomer, terpolymeric ionomer, or elastomer. As discussed above, ideally a golf ball cover should provide good feel and controllability, without sacrificing the ball's distance and durability. Therefore, a copolymeric ionomer having a high flexural modulus often is combined in a cover composition with a terpolymeric ionomer or an elastomer having a low flexural modulus. The resulting intermediate-modulus blend possesses a good combination of hardness, spin, and durability.

However, even with blending of materials to improve properties, use of the materials and blends discussed above has not been completely satisfactory. Improving one characteristic can lead to worsening another. For example, blending an ionomer having a high flexural modulus with an ionomer having a low flexural modulus can lead to reduced resilience and durability compared to use of the high-modulus ionomer alone. Also, the hardnesses of the compositions that can be obtained from these blends are limited, because durability and resilience get worse when hardness is lowed by increasing terpolymeric content of these blends. In general, it is difficult to make materials for use in, for example, a golf ball cover layer that have good feel, high speed, high resilience, and good shear durability, and that are within a wide range of hardness. Additional compositions meeting these criteria therefore are needed.

In view of the above, it is apparent that golf ball compositions are needed that allow the optimization of many ball performance properties without the worsening of other properties. The ball compositions also should provide little or no processing and preparation difficulties over existing compositions. The present invention fulfills this need and other needs, and provides further related advantages.

### SUMMARY OF THE INVENTION

The present invention is embodied in a golf ball incorporating a composition comprising: ethylene vinyl acetate polymer, ethylene vinyl acetate/acid terpolymer, or mixtures of these, in which the ethylene vinyl acetate polymer, ethylene vinyl acetate/acid terpolymer, or mixture has a vinyl acetate content between about 5% and about 60% and a mean molecular weight between about 10,000 and about 500,000; and a crosslinking agent, activator, co-crosslinking agent, or mixture of these. The present invention also resides in methods for making these golf balls.

The ethylene vinyl acetate polymer, ethylene vinyl acetate/acid terpolymer, or mixture of these preferably has a vinyl acetate content between about 5% and about 50%, more preferably between about 5% and about 45%, and most preferably between about 5% and about 40%. The ethylene vinyl acetate polymer, ethylene vinyl acetate/acid terpolymer, or mixture of these preferably has a mean molecular weight between about 5,000 and about 450,000, more preferably between about 10,000 and about 400,000, and most preferably between about 10,000 and about 350,000.

Preferred crosslinking agents for use in the invention include peroxides, such as dicumyl peroxide. The crosslinking agents also can incorporate a copolymer, terpolymer or mixtures of these, in which the copolymer or terpolymer has a glycidyl group, hydroxyl group, maleic anhydride group or carboxylic group.

In preferred embodiments, the composition also incorporates a blend polymer incorporating ionomeric polymer, non-ionomer, or mixtures of these, so that the ratio by weight of ethylene vinyl acetate polymer, ethylene vinyl acetate/acid terpolymer, or mixtures of these to that of the blend polymer ranges between about 5:95 and about 95:5, more preferably between about 10:90 and about 90:10, more preferably between about 20:80 and about 80:20, and most preferably between about 30:70 and about 70:30. Preferred ionomeric blend polymers include copolymeric polymers, terpolymeric polymers, or mixtures of these.

In preferred embodiments, the ratio by weight of crosslinking agent to the combined weight of ethylene vinyl acetate polymer and ethylene vinyl acetate/acid terpolymer ranges between about 0.1:100 and about 10:100, and more preferably between about 0.1:100 and about 5:100. The preferred ratio by weight of the combined weight of crosslinking agent and crosslinking activator to the combined weight of ethylene vinyl acetate polymer, ethylene vinyl acetate/acid terpolymer, and blend polymer ranges between about 0.1: 100 and about 20: 100. The preferred ratio by weight of the combined weight of crosslinking agent and crosslinking activator to the combined weight of ethylene vinyl acetate polymer, ethylene vinyl acetate/acid terpolymer, and blend polymer ranges between about 0.1:100 and about 10:100.

When the crosslinking agent incorporates the copolymer or terpolymer having a glycidyl group, hydroxyl group, maleic anhydride group or carboxylic group discussed above, the preferred ratio by weight of this copolymer and terpolymer to the combined weight of ethylene vinyl acetate polymer, ethylene vinyl acetate/acid terpolymer, and blend polymer ranges between about 1:100 and about 20:100, more preferably between about 1:100 and about 15:100.

The compositions in the golf balls of the present invention can also incorporate UV stabilizers, photostabilizers, photoinitiators, co-initiators, antioxidants, colorants, dispersants, mold releasing agents, processing aids, inorganic fillers, organic fillers, metallic fillers, or mixtures of these.

As stated above, the present invention also resides in methods for making the golf balls incorporating the compositions described above. Preparation of the composition can incorporate dry-blending the composition, or mixing the composition using a mill, internal mixer or extruder. This mixing can include melting the composition.

Methods within the scope of the present invention also can incorporate: preparing a concentrate incorporating the above-specified ethylene vinyl acetate polymer, ethylene vinyl acetate/acid terpolymer, or mixture of these and a crosslinking agent, activator, co-crosslinking agent, or mixture of these; and adding the concentrate to an intermediate composition incorporating the ethylene vinyl acetate polymer, ethylene vinyl acetate/acid terpolymer, or mixture of these and the blend polymer described above. Alternatively, the method can incorporate: preparing a concentrate incorporating an ionomeric or nonionomeric polymer and a crosslinking agent, activator, co-crosslinking agent, or mixture of these; and adding the concentrate to an intermediate composition comprising ethylene vinyl acetate polymer, ethylene vinyl acetate/acid terpolymer, or a mixture of these, and the blend polymer described above.

In the method of the present invention, incorporating the composition into a golf ball can include injection molding the composition to form a spherical layer of the golf ball. The method also can incorporate injection molding the composition to form a first and a second half shell configured to mate to form a spherical layer; and compression molding the first and second half shells over a central ball portion to form a spherical layer.

In the method of the present invention, preparing the composition can can include inducing crosslinking in the composition during mixing of the composition, for example, by injection molding the composition to form a portion of the golf ball, including forming dimples on an outer surface of the portion. Alternatively, the composition can be incorporated into a golf ball by injection molding the composition to form a portion of the golf ball; and then inducing crosslinking of the composition by compression molding the portion, including forming dimples on an outer surface of the portion. Alternatively, the composition can be injection molding to form two half-shells configured to form a spherical layer when joined together, and then crosslinking can be induced in the composition by compression molding the two half-shells to join the half-shells to form a spherical layer of the golf ball. Crosslinking in the composition also can be induced, for example, by exposing the composition to radiation of an intensity and type sufficient to induce crosslinking.

Other features and advantages of the present invention should become apparent from the following detailed description of the preferred embodiments.

### DESCRIPTION OF THE PREFERRED EMBODIMENTS

The present invention is embodied in compositions for use in making golf balls that incorporate an ethylene vinyl acetate copolymer, ethylene vinyl acetate/acid terpolymer, or mixtures of these, along with a crosslinking agent, crosslinking activator, crosslinking accelerator, co-crosslinking agent, or mixtures of these. The invention also is embodied in golf ball covers, intermediate layers, and cores made from the above-specified compositions, and it additionally resides in methods of manufacture of balls incorporating these compositions. Compositions within the scope of the present invention provide flexibility in golf ball design to improve ball performance, such as hit feel and spin rate, without adversely affecting shear-cut resistance of the ball.

Preferred embodiments of the present invention suitable for use in making golf ball cores, intermediate layers, or covers include compositions comprising: (a) ethylene vinyl acetate copolymer, ethylene vinyl acetate/acid terpolymer, or a mixture of these, having a vinyl acetate content between about 5% and about 60%; (b) a blend polymer, which can include ionomeric polymers, nonionomeric polymers, or mixtures of these; and (c) a crosslinking agent, activator, accelerator, co-crosslinking agent, or mixtures of these. Preferably, the ratio by weight of component (a) to component (b) ranges between about 5:95 and about 95:5, more preferably about 10:90 and about 90:10, more preferably about 20:80 and about 80:20, and most preferably about 30:70 and about 70:30.

The crosslink density of compositions within the scope of the present invention can be adjusted by varying the amount or type of component (c) in the composition. The ratio by weight of crosslinking agent to (a) and (b) combined preferably ranges between about 0.1:100 and about 10:100, more preferably about 0.1:100 and about 5:100. The ratio of co-crosslinking agent and/or crosslinking activator to (a) and (b) combined ranges between about 0.1:100 and about 20:100 by weight, more preferably about 0.1:100 and about 10:100.

Many different types of ethylene vinyl acetate copolymers and ethylene vinyl acetate/acid terpolymers exist, having widely varying physical properties based on their differing vinyl acetate content and molecular weight. These various combinations of vinyl acetate content and molecular weight provide for many different types of these polymers having very different processability, as well as other chemical, thermal, mechanical, and rheological properties. Golf balls within the scope of the present invention include ethylene vinyl acetate copolymers and/or ethylene vinyl acetate/acid terpolymers having a percentage content of vinyl acetate between about 5% and about 60%, more preferably about 5% and about 50%, more preferably about 5% and about 45%, and most preferably between about 5% and about 40%. Golf balls within the scope of the present invention include ethylene vinyl acetate copolymers and/or ethylene vinyl acetate/acid terpolymers having a mean molecular weight between about 5,000 and about 500,000, more preferably between about 5,000 and about 450,000, more preferably between about 10,000 and about 400,000, and most preferably between about 10,000 and about 350,000.

Ethylene vinyl acetate copolymers suitable for use in compositions within the scope of the present invention are polymerized from ethylene and vinyl acetate. Examples of ethylene vinyl acetate copolymers suitable for use in golf balls within the scope of the present invention include Elvax 150, Elvax 240, Elvax 250, Elvax 260, Elvax 265, Elvax 350, Elvax 360, Elvax 450, Elvax 460, Elvax 466, Elvax 470, Elvax 550, Elvax 560, Elvax 650Q, Elvax 660, Elvax 670, Elvax 750, Elvax 760, Elvax 770, Elvax 880, Elvax CM595, Elvax CM576, Elvax CM3326, Elvax 40L03, Elvax 40L08, Elvax CM4875, Elvax 40W, Elvax 3134Q, and Elvax 3182, marketed by by E. I. DuPont de Nemours & Company of Wilmington, Del. Examples of ethylene vinyl acetate/acid terpolymers suitable for use in golf balls within the scope of the present invention include Elvax 4260, Elvax 4310, Elvax 4320, and Elvax 4355 marketed by E. I. DuPont de Nemours.

Preferred crosslinking agents for use with the present invention include peroxides. Examples of suitable peroxides include aliphatic peroxides, aromatic peroxides, or mixtures of these. Primary, secondary, or tertiary peroxides can be used, with tertiary peroxides most preferred. Peroxides that are mono-, di-, tri-, tetra-, or multi-functional or mixtures of these, can be used. Also, peroxides containing more than one peroxy group can be used, such as 2,5-bis-(ter.butylperoxy)-2,5-dimethyl hexane and 1,4-bis-(ter.butylperoxy-isopropyl)-benzene. Also, peroxides that are either symmetrical or asymmetric can be used, such as tert. butylperbenzoate and tert. butylcumyl-peroxide. Additionally, peroxides having carboxyl groups also can be used. Decomposition to promote crosslinking of peroxides can be used in compositions within the scope of the present invention, and this decomposition can be brought by applying thermal energy, radiation energy, shear, reactions with other chemical ingredients, or a combination of these. Homolytically decomposed peroxide, heterolytically decomposed peroxide, or a mixture of those can be used to promote crosslinking reactions with compositions within the scope of this invention. Examples of suitable peroxide compounds for use in compositions within the scope of the present invention include aliphatic peroxides or aromatic peroxides, such as diacetylperoxide, di-tert-butylperoxide, dibenzoylperoxide, dicumylperoxide, 2,5-bis-(t-butylperoxy)-2,5-dimethyl hexane, 2,5-dimethyl-2,5-di(benzoylperoxy)hexane, 2,5-dimethyl-2,5-di(butylperoxy)-3-hexyne, n-butyl-4,4-bis(t-butylperoxyl) valerate, 1,4-bis-(t-butylperoxy-isopropyl)-benzene, t-butyl peroxybenzoate, and 1,1-bis(t-butylperoxy)-3,3,5 tri-methylcyclohexane, di(2,4-dichloro-benzoyl).

Additional preferred crosslinking agents, as well as preferred activators, accelerators, and co-crosslinking agents, incorporate a copolymer or terpolymer having a glycidyl group, hydroxyl group, maleic anhydride group or carboxylic group. When these polymers are used in the compositions of the present invention, the ratio by weight of the copolymer or terpolymer to the combined weight of (a) and (b) ranges between about 1:100 and about 20:100, and more preferably about 1:100 and about 15:100. These copolymers and terpolymers comprise an α-olefin. Examples of suitable α-olefins include ethylene, propylene, 1-butene, 1-pentene, 3-methyl-1-butene, 1-hexene, 4-methyl-1-petene, 3-methyl-1-pentene, 1-octene, 1-decene-, 1-dodecene, 1-tetradecene, 1-hexadecene, 1-octadecene, 1-eicocene, 1-dococene, 1-tetracocene, 1-hexacocene, 1-octacocene, and 1-triacontene. One or more of these α-olefins may be used.

Examples of suitable glycidyl groups in copolymers or terpolymers for use as crosslinking agents within the scope of the present invention include esters and ethers of aliphatic glycidyl, such as allylglycidylether, vinylglycidyl-ether, glycidyl maleate and itaconatem glycidyl acrylate and methacrylate, and also alicyclic glycidyl esters and ethers, such as 2-cyclohexene-1-glycidylether, cyclohexene-4,5-diglyxidylcarboxylate, cyclohexene-4-glycidyl carobxylate, 5-norboenene-2-methyl-2-glycidyl carboxylate, and endocis-bicyclo(2,2,1)-5-heptene-2,3-diglycidyl dicaroboxylate. These polymers having a glycidyl group may comprise other monomers, such as esters of unsaturated carboxylic acid; for example, alkyl(meth)acrylates or vinyl esters of unsaturated carboxylic acids. Polymers having a glycidyl group can be obtained by copolymerization or graft polymerization with homopolymers or copolymers. Examples of suitable terpolymers having a glycidyl group include LOTADER AX8900 and LOTADER AX8920 marketed by Elf-Atochem Company, ELVALOY marketed by Du Pont, REXPEARL marketed by Nippon Petrochemicals Co., Ltd.

Additional examples of polymers incorporating glycidyl groups that are suitable for use as crosslinking agents within the scope of the present invention include copolymers comprising epoxy monomers. These include styrene-butadiene-styrene block copolymers in which the polybutadiene block contains epoxy group, and styrene-isoprene-styrene block copolymers in which the polyisoprene block contains epoxy. Commercially available examples of these epoxy functional copolymers include ESBS A1005, ESBS A1010, ESBS A1020, ESBS AT018, and ESBS AT019, marketed by Daicel Chemical Industries, Ltd.

Examples of polymers or terpolymers incorporating a maleic anhydride group suitable for use as crosslinking agents, activators, accelerators, and co-crosslinking agents within the scope of the present invention include maleic anhydride-modified ethylene-propylene copolymers, maleic anhydride-modified ethylene-propylene-diene terpolymers, maleic anhydride-modified polyethylenes, maleic anhydride-modified polypropylenes, ethylene-ethylacrylate-maleic anhydride terpolymers, and maleic anhydride-indene-styrene-cumarone polymers. Examples of commercially available copolymers incorporating maleic anhydride include: BONDINE, marketed by Sumitomo Chemical Co., such as BONDINE AX8390, an ethylene-ethyl acrylate-maleic anhydride terpolymer having a combined ethylene acrylate and maleic anhydride content of 32% by weight, and BONDINE TX TX8030, an ethylene-ethyl acrylate-maleic anhydride terpolymer having a combined ethylene acrylate and maleic anhydride content of 15% by weight and a maleic anhydride content of 1% to 4% by weight; maleic anhydride-containing LOTADER 3200, 3210, 6200, 8200, 3300, 3400, 3410, 7500, 5500, 4720, and 4700, marketed by Elf-Atochem; EXXELOR VA1803, a maleic anhydride-modified ethylene-propylene copolymer having a maleic anhydride content of 0.7% by weight, marketed by Exxon Chemical Co.; and KRATON FG 1901X, a maleic anhydride functionalized triblock copolymer having polystyrene endblocks and poly(ethylene/butylene) midblocks, marketed by Shell Chemical.

Examples of other suitable crosslinking agents for use within the scope of the present invention include m-pheylenedimaleimide, poly-p-dinitrosobenzene, tellurium, selenium, diisocyanates, triisocyanates, aromatic polyisocyanate, polyisocyanate, polymethylolphenolic resins, polyamines, quinonedioximes, and 4,4′methylenebis(cyclohexylamine)carbamate. Additional examples of suitable activators or co-crosslinking agents include: zinc isopropylxanthate, zinc butylxanthate, sodium isopropylxanthate, diphenylguadine, di-o-tolylguadine, o-tolylbiguadine, butyraldehydeaniline, tricrotonylidene-tetramine, hexamethylenetetramine, polyethylenepolyamines, cyclohexylethyl-amine, dibutylamine, N,N′-ethylenethio-urea, N,N-diphenylthiourea, N,N′-diethylthiourea, triallylcyanurate (TAC), triallylisocyanurate (TAIC), triallylphosphate (TAP), triallyltrimellitate (TAM), diallylphthalate (DAP), m-phenylene-bis-maleimide, ethyleneglycoldimethacrylate (EDMA), trimethyl-propane trimethacrylate (TPTA), 1,3-butyleneglycol dimethacrylate, silane coupling agent, titanate coupling agent, zirconate coupling agent, aluminate coupling agent, zinc dibutyldithiophosphate, copper diisopropyldithiophosphate, 2-benzothiazole-N-morpholyldisulfide, ZnO, MgO, Ca(OH)₂, PbO, dibutylaminooleate, ethanolamine, di-ethanolamine, 1,3-diphenyl-guanidinephthalate, tri-ethanolamine, butylamine, di-butylamine, di-benzylamine, dimorpholine disulfide zinc acrylate, zinc acrylate, zinc diacrylate, zinc stearate, zinc laurate, and other fatty acids.

As discussed above, compositions within the scope of the present invention can incorporate a blend polymer in addition to the ethylene vinyl acetate and crosslinking agent, activator, or co-crosslinking agent. Examples of suitable blend polymers for use in the present invention include, but are not limited to, the following: thermoplastic elastomer, thermoset elastomer, synthetic rubber, thermoplastic vulcanizate, copolymeric ionomer, terpolymeric ionomer, polycarbonate, polyolefin, polyamide, copolymeric polyamide, polyesters, polyvinyl alcohols, acrylonitrile-butadiene-styrene copolymers, polyurethane, polyarylate, polyacrylate, polyphenyl ether, modified-polyphenyl ether, high-impact polystyrene, diallyl phthalate polymer, metallocene catalyzed polymers, acrylonitrile-styrene-butadiene (ABS), styrene-acrylonitrile (SAN) (including olefin-modified SAN and acrilonitrile styrene acrylonitrile), styrene-maleic anhydryde (S/MA) polymer, styrenic copolymer, functionalized styrenic copolymer, functionalized styrenic terpolymer, styrenic terpolymer, cellulose polymer, liquid crystal polymer (LCP), ehtylene-propylene-diene terpolymer (EPDM), ethylene-propylene coplymer, ethylene vinyl acetate, polyurea, and polysiloxane or any metallocene-catalyzed polymers of these species. Particularly suitable polymers for use as the blend polymer within the scope of the present invention include polyethylene-terephthalate, polybutyleneterephthalate, polytrimethylene-terephthalate, ethylene-carbon monoxide copolymer, polyvinyl-diene fluorides, polyphenylenesulfide, polypropyleneoxide, polyphenyloxide, polypropylene, functionalized polypropylene, polyethylene, ethylene-octene copolymer, ethylene-methyl acrylate, ethylene-butyl acrylate, polycarbonate, polysiloxane, functionalized polysiloxane, copolymeric ionomer, terpolymeric ionomer, polyetherester elastomer, polyesterester elastomer, polyetheramide elastomer, propylene-butadiene copolymer, modified copolymer of ethylene and propylene, styrenic copolymer (including styrenic block copolymer and randomly distributed styrenic copolymer, such as styrene-isobutylene copolymer and styrene-butadiene copolymer), partially or fully hydrogenated styrene-butadiene-styrene block copolymers such as styrene-(ethylene-propylene)-styrene or styrene-(ethylene-butylene)-styrene block copolymers, partially or fully hydrogenated styrene-butadiene-styrene block copolymers with functional group, polymers based on ethylene-propylene-(diene), polymers based on functionalized ethylene-propylene-(diene), dynamically vulcanized polypropylene/ethylene-propylene-diene-copolymer, thermoplastic vulcanizates based on ethylene-propylene-(diene), thermoplastic polyetherurethane, thermoplastic polyesterurethane, compositions for making thermoset polyurethane, thermoset polyurethane, natural rubber, styrene-butadiene rubber, nitrile rubber, chloroprene rubber, fluorocarbon rubber, butyl rubber, acrylic rubber, silicone rubber, chlorosulfonated polyethylene, polyisobutylene, alfin rubber, polyester rubber, epichlorphydrin rubber, chlorinated isobutylene-isoprene rubber, nitrile-isobutylene rubber, 1,2-polybutadiene, 1,4-polybutadiene, cis-polyisoprene, trans-polyisoprene, and polybutylene-octene.

Suitable polyamides for use as the blend polymer in the present invention also include resins obtained by: (1) polycondensation of (a) a dicarboxylic acid, such as oxalic acid, adipic acid, sebacic acid, terephthalic acid, isophthalic acid or 1,4-cyclohexylidicarboxylic acid, with (b) a diamine, such as ethylenediamine, tetramethylenediamine, pentamethylenediamine, hexamethylene-diamine or decamethylenediamine, 1,4-cyclohexyldiamine or m-xylylenediamine; (2) a ring-opening polymerization of cyclic lactam, such as ε-caprolactam or ω-laurolactam; (3) polycondensation of an aminocarboxylic acid, such as 6-aminocaproic acid, 9-aminononaoic acid, 11-aminoudecanoic acid or 12-aminododecanoic acid; or, (4) copolymerization of a cyclic lactam with a dicarboxylic acid and a diamine. Specific examples of suitable polyamides include Nylon 6, Nylon 66, Nylon 610, Nylon 11, Nylon 12, copolymerized Nylon, Nylon MXD6, and Nylon 46. Preferred materials for use as the blend polymer in the present invention also include polyester elastomers marketed under the name SKYPEL by SK Chemicals of South Korea, or triblock copolymers marketed under the name HG-252 by Kuraray Corporation of Kurashiki, Japan. These triblock copolymers have at least one polymer block comprising an aromatic vinyl compound and at least one polymer block comprising a conjugated diene compound, and a hydroxyl group at a block copolymer.

Golf balls and ball compositions within the scope of the present invention also can include, in suitable amounts, one or more additional ingredients generally employed in golf balls and ball compositions. Agents provided to achieve specific functions, such as additives and stabilizers, can be present. Suitable ingredients include UV stabilizers, photostabilizers, antioxidants, colorants, dispersants, mold releasing agents, and processing aids. Compositions suitable for crosslinking using radiation preferably include photo-initiators, co-initiators, or mixtures of these. Examples of these photo-initiators and co-initiators include dibenzoyl methane, methyl benzoyl formate, benzopinacol, 4-chlorobenzophenone, camphorquinone, 4-chloropropiophenone, 2-ethyl anthraquinone, ethyl p-dimethylamino benzoate, 2-mercaptobenzoxazole, N-phenyl glycine, lophine dimerdibromochalcone, 2,2′-bis(2-chlorophenyl)-4,4′,5,5′-tetraphenyl-1,1′-biimidazole, 2,2′-bis(2-ethoxyphenyl)-4,4′,5,5′-tetraphenyl-1,1′-biimidazole, and 2-(1-naphtyl)-4,5-diphenyl-1,2′-biimidazole.

Golf balls and golf ball compositions within the scope of the present invention also can incorporate inorganic fillers, such as titanium dioxide, calcium carbonate, zinc sulfide or zinc oxide. Additional fillers can be chosen to impart additional density to blends of golf balls and ball compositions within the scope of the present invention, such as zinc oxide, barium sulfate, tungsten or any other metallic powder having density higher than that of base polymeric resin. Any organic or inorganic fibers, either continuous or non-continuous, also can be in the compositions.

The crosslinking agent, activator, accelerator, or co-crosslinking agent, can be mixed into the blend of ethylene vinyl acetate and blend polymer with or without melting the blend. Dry blending equipment, such as a tumbler mixer, V-blender, or ribbon blender, can be used to mix the compositions incorporating ethylene vinyl acetate and blend polymer. The crosslinking agent, crosslinking activator, accelerator, or co-crosslinking agent also can be mixed together or added sequentially to the blend of ethylene vinyl acetate and the blend polymer using a mill, internal mixer, extruder or combinations of these, with or without application of thermal energy to produce melting or chemical reaction. In preparing the preferred embodiments discussed above, any of the additional components can be premixed with the ethylene vinyl acetate and blend polymer to produce a concentrate having a high concentration of the additional components. Then, this concentrate can be introduced into a composition of ethylene vinyl acetate and blend polymer using dry blending or melt mixing. The additional components also can be added to a color concentrate, which is then added to the composition to impart a white color to golf ball. During a melt mixing process, partial crosslinking can be produced by adjusting the resin composition, screw rpm, or processing temperature, if necessary. Any combination of the above-mentioned mixing methods can be used to produce a final composition within the scope of the present invention.

Compositions within the scope of the present invention preferably are prepared using the dry blending or melt mixing methods discussed above, to mold a core, intermediate layer or cover layer of a golf ball. Various methods within the scope of the present invention for forming portions of golf balls take advantage of use of crosslinking agents in the compositions by inducing partial or full crosslinking at various stages of formation of ball cores, intermediate layers, or cover layers. Conditions of the processes used for forming the ball portions can be adjusted to induce the preferred amount of crosslinking and the preferred stages of the process. By adjusting the amount of crosslinking in the compositions, the material properties of the compositions can be tailored as preferred. For example, during injection molding of a layer, crosslinking can be induced by adjusting processing conditions, such as barrel temperature, mold temperature, and cure time. Also, exposure of the formed core, intermediate layer or cover layer to, for example, appropriate levels or radiation can be used to induce a preferred amount of crosslinking in compositions within the scope of the present invention.

In one preferred method, the composition can be partially crosslinked during the mixing process, and then molded into a core, intermediate layer or cover using injection molding, compression molding, or a combination of the two. Another preferred method for making a core, intermediate layer, or cover from compositions within the scope of the present invention involves using forming a composition without inducing crosslinking, and then injection molding the core, intermediate layer, or cover under conditions to induce partial or full crosslinking. Another preferred method involves injection molding a core, intermediate layer, or cover without inducing crosslinking, and then using inducing partial or full crosslinking using secondary methods, such as compression molding or exposure to radiation. In another preferred method, an intermediate layer or a cover can be prepared by injection molding half-shells, and then inducing crosslinking during compression molding to form a complete layer.

When used to form a cover layer, a preferred embodiment of the method involves preparing the cover layer using injection molding and forming dimples on the surface of the cover layer, inducing full or partial curing of the layer during the injection molding process. Alternately, the cover layer can be formed using injection molding without dimples, and then the layer can be compression molded to form dimples and induce full or partial cross-linking.

### EXAMPLES

1. Composition Testing

Three compositions within the scope of the present invention were prepared and tested for tensile strength, tensile elongation, and hardness, both before and after curing of the compositions. The compositions, labeled Blends 1 to 3, incorporated an ethylene vinyl acetate having an acetate content of 18 percent, SURLYN 6120 ionomer, and a crosslinking agent (blends of 2,5-dimethyl-2,5-di(tert-butylperoxy)hexane, dicumyl peroxide, and a 2:1 weight mixture of zinc oxide and zinc stearate), in varying amounts. These compositions and the results for the tested properties are shown in Table 1 below.

TABLE 1

| | Blend No. | | |
|---|---|---|---|
| | 1 | 2 | 3 |
| Percentage weights | | | |
| EVA (18% acetate) | 57.5 | 57.5 | 55 |
| SURLYN | 47.5 | 47.5 | 45 |
| 2,5-dimethyl-2,5-di(tert- | 0.2 | 0.0 | 0.0 |
| butylperoxy)hexane | | | |
| Dicumyl peroxide | 0.0 | 0.2 | 0.3 |
| Zinc oxide/zinc stearate | 0.8 | 0.8 | 0.0 |
| Uncured Property | | | |
| Tensile strength, psi | 2,544 | 2,298 | 2,566 |
| Tensile elongation, % | 96 | 116 | 87 |
| Hardness, Shore D | 51 | 50 | 50 |
| Cured Property | | | |
| Tensile strength, psi | 2,781 | 2,423 | 1,835 |
| Tensile elongation, % | 577 | 493 | 268 |
| Hardness, Shore D | 48 | 48 | 46 |

2. Golf Ball Testing

Golf balls were prepared incorporating each of Blends 1 to 3 as cover compositions, and labeled Ball Types 1 to 3. The balls incorporated cores each having a diameter of 1.58 inches and a PGA compression of 70, and they incorporated covers 0.05 inches thick. Additionally, two marketed balls were tested for the same parameters for comparison; the Titleist NXT Tour and Professional balls. Each of the balls were tested for cover hardness, PGA compression and for shear-cut resistance, determined by examining the balls after they were impacted by a pitching wedge, classifying each numerically from 1 (excellent) to 5 (poor), and averaging the results for a given ball type. The characteristics and results for the tested properties for these balls are shown in Table 2 below.

TABLE 2

| Ball Type | 1 | 2 | 3 | NXT Tour | Profess. |
|---|---|---|---|---|---|
| Cover Hardness Shore D | 53 | 52 | 53 | 60 | 58 |
| PGA Compression | 75 | 76 | 77 | 75 | 86 |
| Shear-cut Resistance | 2.2 | 2.6 | 2.6 | 1.9 | 2.8 |

Additionally, golf balls were prepared having covers incorporating compositions within the scope of the present invention. The balls, labeled Ball Types 4 to 7, incorporated cores each having a diameter of 1.58 inches and a PGA compression of 70, and they incorporated covers 0.05 inches thick. The cover compositions incorporated SURLYN 6120 ionomer, an ethylene vinyl acetate having an acetate content of 18 percent, and dicumyl peroxide as a crosslinking agent, in varying amounts. Additionally, two reference balls were tested for the same parameters for comparison to the balls having covers within the scope of the present invention. Reference Ball 1 balls incorporated an intermediate layer having a Shore D hardness of 40 and a cover incorporating an ionomer blend having a Shore D hardness of 57. Reference Ball 2 balls incorporated no intermediate layer and a cover incorporating an ionomer blend having a Shore D hardness of 60. Each of the finished balls was tested for PGA compression, and also for speed and spin rate when struck by a driver and by a 8 Iron under controlled conditions. The characteristics and results for the tested properties for these balls are shown in Table 3 below.

TABLE 3

| Ball Type | 4 | 5 | 6 | 7 | Ref. 1 | Ref. 2 |
|---|---|---|---|---|---|---|
| Percentage | | | | | | |
| weights | | | | | | |
| EVA | 40 | 50 | 40 | 50 | N/A | N/A |
| (18% acetate) | | | | | | |
| SURLYN 6120 | 60 | 50 | 60 | 50 | N/A | N/A |
| Dicumyl | 0.4 | 0.4 | 0.6 | 0.6 | N/A | N/A |
| peroxide pph | | | | | | |
| Cover hardness | 61 | 59 | 62 | 60 | 57 | 60 |
| Shore D | | | | | | |
| PGA | 73 | 71 | 71 | 71 | 75 | 71 |
| Compression | | | | | | |
| Driver Speed | 161.6 | 161.2 | 161.0 | 160.2 | 160.5 | 161.5 |
| mph | | | | | | |
| Driver Spin | 2,726 | 2,581 | 2,888 | 2,865 | 2,868 | 3,169 |
| Rate rpm | | | | | | |
| 8 Iron Speed | 111.2 | 110.2 | 110.2 | 110.2 | 110.2 | 109.4 |
| mph | | | | | | |
| 8 Iron Spin | 7,335 | 7,496 | 7,807 | 8,098 | 7,897 | 7,367 |
| Rate rpm | | | | | | |

### DISCUSSION

Upon review of the data, it is apparent that balls within the scope of the present invention provide for good performance properties. Particular balls within the scope of the present invention can be selected to maximize properties of greatest interest to a particular golfer. For example, Table 2 illustrates that the balls provide substantially lower cover hardness than NXT Tour and Professional Reference balls. Also, Ball Type 4 in Table 3 provides for a ball having high ball speed off a driver or 8 Iron, with low spin rates. This ball would be particularly suited for a player who wishes to hit a ball with good distance, but without difficulty in controlling the ball. Ball Type 6 provides for good ball speed as well as low spin, but with greater 8 Iron spin rate than provided by Ball Type 4, for players more able to take advantage of spin. Ball Type 7 provides for comparable speeds and still greater 8 Iron spin rate, higher than that of the Reference balls having a three-piece construction. This illustrates the huge flexibility in ball design provided by use of the composition of the present invention. It also is noted that though all of Balls 1 to 7 included crosslinking agent in their compositions, processing conditions during manufacture of these balls were not adjusted to optimize the degree of crosslinking. Therefore, it is assumed that were these processing conditions so adjusted, the performance of Balls 1 to 7 would be further improved. In general, by selecting the amount and type of ethylene vinyl acetate, blend polymer, and crosslinking agent, as well as the amount of crosslinking, balls can be prepared to meet a variety of preferred performance properties.

Although the invention has been disclosed in detail with reference only to the preferred embodiments, those skilled in the art will appreciate that additional golf ball covers can be made without departing from the scope of the invention. Accordingly, the invention is identified by the following claims.

I claim:

1. A golf ball incorporating a composition comprising:
ethylene vinyl acetate polymer, ethylene vinyl acetate/acid terpolymer, or mixtures thereof, wherein the ethylene vinyl acetate polymer, ethylene vinyl acetate/acid terpolymer, or mixture thereof has a vinyl acetate content between about 5% and about 60% and a mean molecular weight between about 10,000 and about 500,000; and
a crosslinking agent, activator, co-crosslinking agent, or mixtures thereof.

2. A golf ball as defined in claim 1, wherein the ethylene vinyl acetate polymer, ethylene vinyl acetate/acid terpolymer, or mixture thereof has a vinyl acetate content between about 5% and about 50%.

3. A golf ball as defined in claim 2, wherein the ethylene vinyl acetate polymer, ethylene vinyl acetate/acid terpolymer, or mixture thereof has a vinyl acetate content between about 5% and about 45%.

4. A golf ball as defined in claim 3, wherein the ethylene vinyl acetate polymer, ethylene vinyl acetate/acid terpolymer, or mixture thereof has a vinyl acetate content between about 5% and about 40%.

5. A golf ball as defined in claim 1, wherein the ethylene vinyl acetate polymer, ethylene vinyl acetate/acid terpolymer, or mixture thereof has a mean molecular weight between about 5,000 and about 450,000.

6. A golf ball as defined in claim 5, wherein the ethylene vinyl acetate polymer, ethylene vinyl acetate/acid terpolymer, or mixture thereof has a mean molecular weight between about 10,000 and about 400,000.

7. A golf ball as defined in claim 6, wherein the ethylene vinyl acetate polymer, ethylene vinyl acetate/acid terpolymer, or mixture thereof has a mean molecular weight between about 10,000 and about 350,000.

8. A golf ball as defined in claim 1, wherein the crosslinking agent comprises peroxide.

9. A golf ball as defined in claim 8, wherein the peroxide is selected from the group consisting of dicumyl peroxide, 2,5-dimethyl-2,5-di(tert-butylperoxy)hexane, and mixtures of these.

10. A golf ball as defined in claim 1, wherein the crosslinking agent comprises a copolymer, terpolymer or mixtures thereof, the copolymer or terpolymer having a glycidyl group, hydroxyl group, maleic anhydride group or carboxylic group.

11. A golf ball as defined in claim 1, wherein the composition further comprises a blend polymer comprising ionomeric polymer, non-ionomer, or mixtures thereof;
wherein the ratio by weight of ethylene vinyl acetate polymer, ethylene vinyl acetate/acid terpolymer, or mixtures thereof to the blend polymer ranges between about 5:95 and about 95:5

12. A golf ball composition as defined in claim 11 wherein the ratio by weight of ethylene vinyl acetate polymer, ethylene vinyl acetate/acid terpolymer, or mixtures thereof to the blend polymer ranges between about 10:90 and about 90:10.

13. A golf ball composition as defined in claim 12, wherein the ratio by weight of ethylene vinyl acetate polymer, ethylene vinyl acetate/acid terpolymer, or mixtures thereof to the blend polymer ranges between about 20:80 and about 80:20.

14. A golf ball composition as defined in claim 13, wherein the ratio by weight of ethylene vinyl acetate polymer, ethylene vinyl acetate/acid terpolymer, or mixtures thereof to the blend polymer ranges between about 30:70 and about 70:30.

15. A golf ball as defined in claim 11, wherein the ionomeric polymer comprises copolymeric polymers, terpolymeric polymers, or mixtures thereof.

16. A golf ball as defined in claim 11, wherein the ratio by weight of crosslinking agent to ethylene vinyl acetate polymer, ethylene vinyl acetate/acid terpolymer, or mixtures thereof and blend polymer ranges between about 0.1:100 and about 10:100.

17. A golf ball as defined in claim 16, wherein the ratio by weight of crosslinking agent to ethylene vinyl acetate polymer, ethylene vinyl acetate/acid terpolymer, or mixtures thereof and blend polymer ranges between about 0.1:100 and about 5:100.

18. A golf ball as defined in claim 17, wherein the ratio by weight of crosslinking agent and crosslinking activator to ethylene vinyl acetate polymer, ethylene vinyl acetate/acid terpolymer, or mixtures thereof and blend polymer ranges between about 0.1:100 and about 20:100.

19. A golf ball as defined in claim 18, wherein the ratio by weight of crosslinking agent and crosslinking activator to ethylene vinyl acetate polymer, ethylene vinyl acetate/acid terpolymer, or mixtures thereof and blend polymer ranges between about 0.1:100 and about 10:100.

20. A golf ball as defined in claim 11, wherein:
the crosslinking agent comprises a copolymer, terpolymer or mixtures thereof, the copolymer or terpolymer having a glycidyl group, hydroxyl group, maleic anhydride group or carboxylic group; and
the ratio by weight of copolymer and terpolymer having a glycidyl group, hydroxyl group, maleic anhydride group or carboxylic group to ethylene vinyl acetate polymer, ethylene vinyl acetate/acid terpolymer, and blend polymer ranges between about 1:100 and about 20:100.

21. A golf ball composition as defined in claim 20, wherein the ratio by weight of copolymer and terpolymer having a glycidyl group, hydroxyl group, maleic anhydride group or carboxylic group to the ethylene vinyl acetate polymer, ethylene vinyl acetate/acid terpolymer, and blend polymer ranges between about 1:100 and about 15:100.

22. A golf ball as defined in claim 1, wherein the composition further comprises UV stabilizers, photostabilizers, photoinitiators, co-initiators, antioxidants, colorants, dispersants, mold releasing agents, processing aids, inorganic fillers, organic fillers, metallic fillers, or mixtures thereof.

23. A method for making a golf ball, comprising:
preparing a composition comprising
ethylene vinyl acetate polymer, ethylene vinyl acetate/acid terpolymer, or mixtures thereof, wherein the ethylene vinyl acetate polymer, ethylene vinyl acetate/acid terpolymer, or mixture thereof has a vinyl acetate content between about 5% and about 60% and a mean molecular weight between about 10,000 and about 500,000; and
a crosslinking agent, activator, co-crosslinking agent, or mixtures thereof; and
incorporating the composition into the golf ball.

24. A method as defined in claim 23, wherein the step of preparing a composition comprises a step of dry-blending the composition.

25. A method as defined in claim 23, wherein the step of preparing a composition comprises a step of mixing the composition using a mill, internal mixer or extruder.

26. A method as defined in claim 25, wherein the step of mixing the composition comprises melting the composition.

27. A method as defined in claim 23, wherein the step of preparing a composition comprises:
preparing a concentrate comprising:
ethylene vinyl acetate polymer, ethylene vinyl acetate/acid terpolymer, or mixtures thereof, wherein the ethylene vinyl acetate polymer, ethylene vinyl acetate/acid terpolymer, or mixture thereof has a vinyl acetate content between about 5% and about 60% and a mean molecular weight between about 10,000 and about 500,000; and
a crosslinking agent, activator, co-crosslinking agent, or mixtures thereof; and
adding the concentrate to an intermediate composition comprising: ethylene vinyl acetate polymer, ethylene vinyl acetate/acid terpolymer, or mixtures thereof having a vinyl acetate content between about 5% and about 60% and a mean molecular weight between about 10,000 and about 500,000; and, a blend polymer comprising ionomeric polymer, non-ionomer, or mixtures thereof.

28. A method as defined in claim 23, wherein the step of preparing a composition comprises:
preparing a concentrate comprising:
an ionomeric polymer and
a crosslinking agent, activator, co-crosslinking agent, or mixtures thereof; and
adding the concentrate to an intermediate composition comprising: ethylene vinyl acetate polymer, ethylene vinyl acetate/acid terpolymer, or mixtures thereof having a vinyl acetate content between about 5% and about 60% and a mean molecular weight between about 10,000 and about 500,000; and, a blend polymer comprising ionomeric polymer, non-ionomeric polymer, or mixtures thereof.

29. A method as defined in claim 23, wherein the step of preparing a composition comprises.
preparing a concentrate comprising:
a non-ionomeric polymer and
a crosslinking agent, activator, co-crosslinking agent, or mixtures thereof; and
adding the concentrate to an intermediate composition comprising: ethylene vinyl acetate polymer, ethylene vinyl acetate/acid terpolymer, or mixtures thereof having a vinyl acetate content between about 5% and about 60% and a mean molecular weight between about 10,000 and about 500,000; and, a blend polymer comprising ionomeric polymer, non-ionomeric polymer, or mixtures thereof.

30. A method as defined in claim 23, wherein the step of incorporating the composition into a golf ball comprises injection molding the composition to form a spherical layer of the golf ball.

31. A method as defined in claim 23, wherein the ball comprises a central portion and the step of incorporating the composition into a golf ball comprises:
injection molding the composition to form a first and a second half shell, the half shells configured to mate to form a spherical layer; and
compression molding the first and second half shells over the central portion to form a spherical layer.

32. A method as defined in claim 23, wherein the step of preparing the composition comprises inducing crosslinking in the composition during mixing of the composition.

33. A method as defined in claim 32, wherein the step of incorporating the composition into a golf ball comprises inducing crosslinking in the composition by injection molding the composition to form a portion of the golf ball.

34. A method as defined in claim 33, wherein the step of inducing crosslinking in the composition by injection molding the composition comprises forming dimples on an outer surface of the portion.

35. A method as defined in claim 32, wherein the step of incorporating the composition into a golf ball comprises injection molding the composition to form a portion of the golf ball; and
inducing crosslinking of the composition by compression molding the portion.

36. A method as defined in claim 35, wherein the step of inducing crosslinking in the composition during compression molding of the composition comprises forming dimples on an outer surface of the portion.

37. A method as defined in claim 32, wherein the step of incorporating the composition into a golf ball comprises:
injection molding the composition to form two half-shells configured to form a spherical layer when joined together; and
inducing crosslinking in the composition by compression molding the two half-shells to join the half-shells to form a spherical layer of the golf ball.

38. A method as defined in claim 33, wherein the step of inducing crosslinking in the composition by exposing the composition to radiation of an intensity and type sufficient to induce crosslinking.
